(19) United States
(12) Patent Application Publication
(10) Pub. No.: US 2020/0238795 A1
(43) Pub. Date: Jul. 30, 2020

(54) WINDOW ASSEMBLY HAVING FLUSH FRAME TO SASH

(71) Applicant: Fleetwood Aluminum Products, Inc., Corona, CA (US)

(72) Inventors: Mark S. McCoy, North Tustin, CA (US); Kevin M. Nguyen, Eastvale, CA (US)

(73) Assignee: Fleetwood Aluminum Products, Inc., Corona, CA (US)

(21) Appl. No.: 16/259,841

(22) Filed: Jan. 28, 2019

(51) Int. Cl. B60J 1/00

(52) U.S. Cl. CPC B60J 1/004; B60J 1/008

(57) ABSTRACT

A window assembly for installing in a window opening of a building. The window assembly comprises a window sash pivotally mounted in a window frame such that the window sash can be pivoted between a closed position in the window frame and an open position. When the window sash is in the closed position in the window frame, the window frame and window sash have a flush exterior interface and a flush interior interface, between the window frame and window sash.

### BACKGROUND

The field of the invention generally relates to windows on buildings, and more particularly, to a window assembly having a flush frame to sash interface.

Windows on buildings, such as residential homes, apartments buildings, and business offices, typically comprise a window frame installed in an opening in a wall of the building, and a window sash made up of a sash frame holding one or more glass panes. There are a variety of most common styles of windows, including casement windows, double-hung windows, slider windows, and picture/fixed windows, to name a few.

Casement windows have a sash which is attached to one side of the frame with a hinge such that the window sash opens by pivoting about the hinge. The hinge may be hinged at the top (commonly called an awning window), bottom (commonly called a hopper window) or side. The window may have a crank, lever or cam handle to open and close the window. A cross-section of a previously disclosed casement window is shown in FIG. 1. As shown in FIG. 1, the casement window 1 includes a window frame 2 which is configured to be installed in a window opening in the wall of the building. A window sash 3 installs into the window frame 2. The window sash 3 includes a sash frame 4 and one or more glass panes 5a, 5b. As can be seen in FIG. 1, the sash 3 has an exterior overhang 6 on the exterior of the window 1 where the sash frame 4 extends outward from the frame 2. Similarly, the frame 2 has an interior overhang 7 on the interior of the window 1 where the frame 2 extends inward from the sash frame 4. As a result of the overhangs 6 and 7, previously disclosed casement windows, and building windows in general, do not have a flush interior and exterior interface between the window frame and window sash.

### SUMMARY

The present invention is directed to an innovative window assembly for installing in a window opening of a building. The window assembly comprises a window sash pivotally mounted in a window frame such that the window sash can be pivoted between a closed position in the window frame and an open position. When the window sash is in the closed position in the window frame, the window frame and window sash have a flush exterior interface and a flush interior interface, between the window frame and window sash. As used herein, the term “flush” means that a respective surface of each of the referenced structures are even with each other such that no part protrudes out more than the other.

Accordingly, in one embodiment, the window assembly comprises a window frame configured to be installed in a window opening of a building, and a window sash mounted in the window frame. The window frame includes a frame base having an outer wall which forms the outer perimeter of the window frame. The frame base has an interior end and an exterior end. A frame interior wall extends inwardly from the interior end of the frame base, and a frame exterior wall extends inwardly from the exterior end of the frame base. As used herein, the terms “inwardly” and “outwardly” are relative to the perimeter and middle of the window assembly in a elevational view of the window assembly, such that “inwardly” means toward the middle of the window, and “outwardly” means toward the perimeter of the window. An extension wall extends exteriorly from the frame exterior wall. The extension wall extends exteriorly such that an exterior end of the extension wall is flush with the outside surface of a sash exterior wall of the sash.

The sash comprises a sash frame and one or more glass panes mounted in the sash frame. The sash frame includes a sash base which extends from an exterior end to an interior end. A sash interior wall extends inwardly from the interior end of the sash base. An interior surface of the sash interior wall is flush with an interior surface of the frame interior wall when the window sash is in the closed position in the window frame. The sash frame also has an interior interface wall which extends outwardly from the sash base at a location exterior of the sash interior wall, such that the interior interface wall is recessed from the sash interior wall. The interior interface wall seals against a frame seal on the inside surface of the frame exterior wall when the sash is closed in the window frame, and allows the sash to open outward from the window frame. The sash frame has a sash exterior wall extending outwardly from the exterior end of the sash base. As described above, the exterior surface of the sash exterior wall is flush with the exterior end of the extension wall. The sash exterior wall has a sash seal which seals against the frame exterior wall when the sash is closed in the window frame, and allows the sash to open outward from the window frame.

Accordingly, the window assembly provides a window frame and window sash which have a flush frame to sash appearance. In other words, the sash is flush with the frame, which reduces protruding structure which can accumulate dust and moisture, and also provides a very clean and modern look.

In another aspect, the window assembly may further comprise a frame thermal break disposed in the frame base, and/or a sash thermal break disposed in the sash base. The frame thermal comprises a thermal insulator separating an exterior portion of the frame base from an interior portion of the frame base which reduces the thermal conductivity between the exterior portion and interior portion of the frame. The sash thermal comprises a thermal insulator separating an exterior portion of the sash base from an interior portion of the sash base which reduces the thermal conductivity between the exterior portion and interior portion of the sash.

In still another feature, the window assembly may also have a pair of convection seals, a frame convection seal and a sash convection seal, for reducing heat convection between the exterior and interior of the window assembly. A first convection seal is disposed on an inward surface of the frame base, such as on an inward surface of the frame thermal break. A second convection seal is disposed on an outward surface of the sash base, such as on an outward surface of the sash thermal break. The first and second seals seal against one another when the sash is closed in frame. The first and second seals form an air barrier within a cavity formed between the frame base and sash base which reduces heat convection between the exterior portion and interior portion of the window assembly.

In still another aspect of the window assembly, a first pane seal is disposed on an exterior surface of the interior interface wall of the sash which bears against and holds the interior surface of a glass assembly. The glass assembly includes one or more glass panes. A second pane seal is disposed on an interior surface of an exterior pane support mounted on the sash base. The second pane seal bears against and holds the exterior surface of the glass assembly.

In another aspect, the window assembly is installed in a window opening in a wall of a building such that the exterior surface of the frame and sash are flush with the exterior surface of the wall and/or the interior surface of the frame and sash are flush with the interior surface of the wall.

Another embodiment of the present invention is directed to a method of installing the window assembly in a window opening of a wall of the building. The window assembly is mounted in the window opening such that the exterior surface of the frame and sash are flush with the exterior surface of the wall and/or the interior surface of the frame and sash are flush with the interior surface of the wall.

### BRIEF DESCRIPTION OF THE DRAWINGS

The foregoing and other aspects of embodiments are described in further detail with reference to the accompanying drawings, wherein like reference numerals refer to like elements and the description for like elements shall be applicable for all described embodiments wherever relevant:

FIG. 1 is a side, cross-sectional view of a window assembly in the prior art;

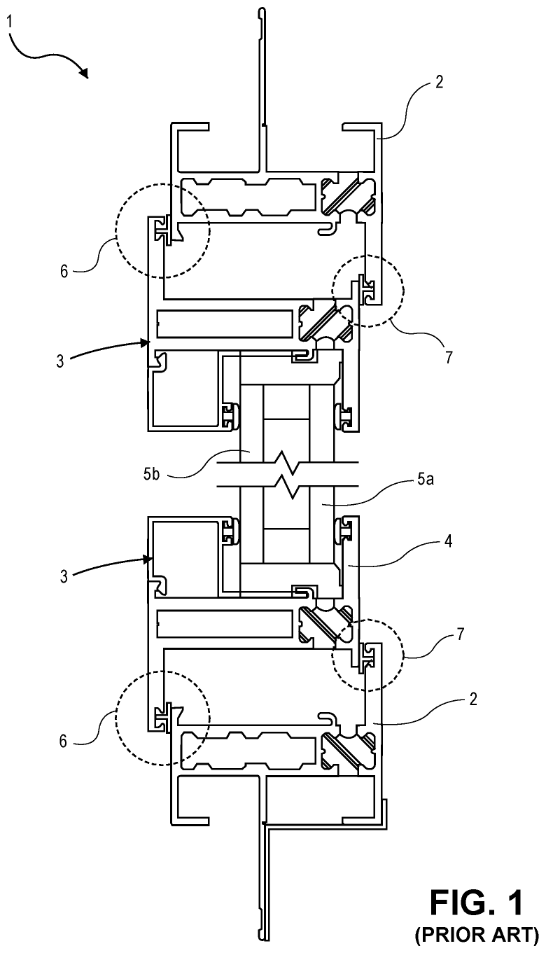

FIG. 2 is a front, perspective view of a window assembly with the window sash in the open position, according to one embodiment of the present invention;

FIG. 3 is a front, perspective view of the window assembly of FIG. 2 with the window sash in the closed position, according to one embodiment of the present invention

FIG. 4 is a rear, perspective view of the window assembly of FIG. 2 with the window sash in the open position, according to one embodiment of the present invention;

FIG. 5 is a rear, perspective view of the window assembly of FIG. 2 with the window sash in the closed position, according to one embodiment of the present invention;

FIG. 6 is a side, cross-sectional view of the window assembly of FIG. 2, according to one embodiment of the present invention; and

FIG. 7 is a partial, side, cut-away perspective view of the window assembly of FIG. 2, according to one embodiment of the present invention.

### DETAILED DESCRIPTION

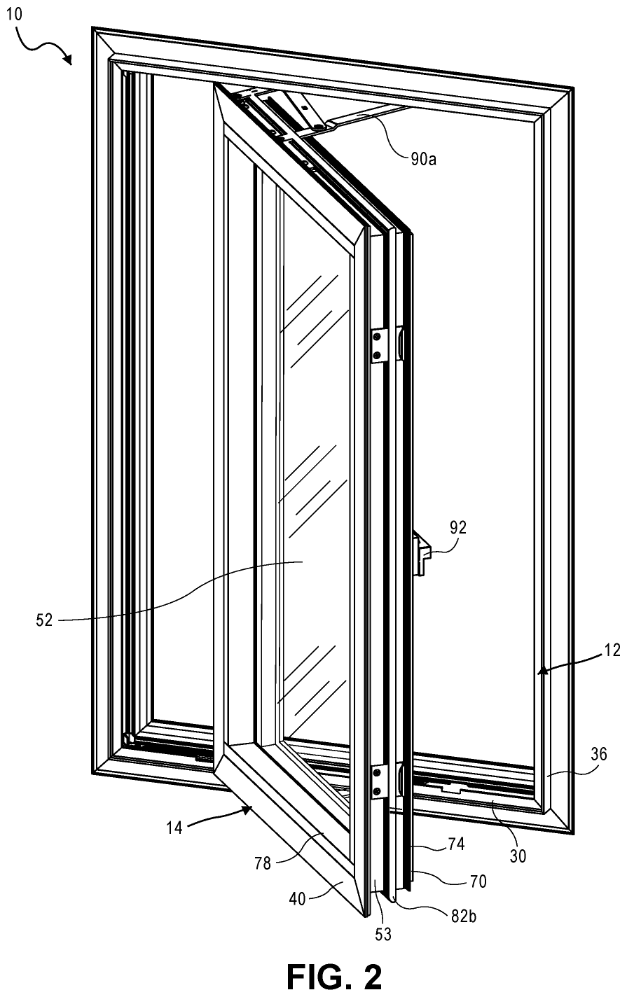

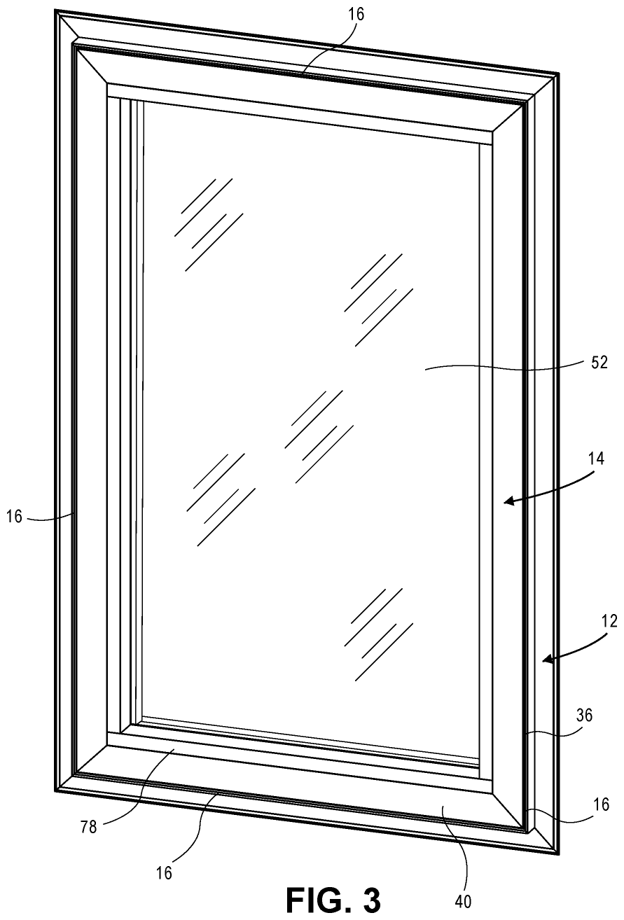

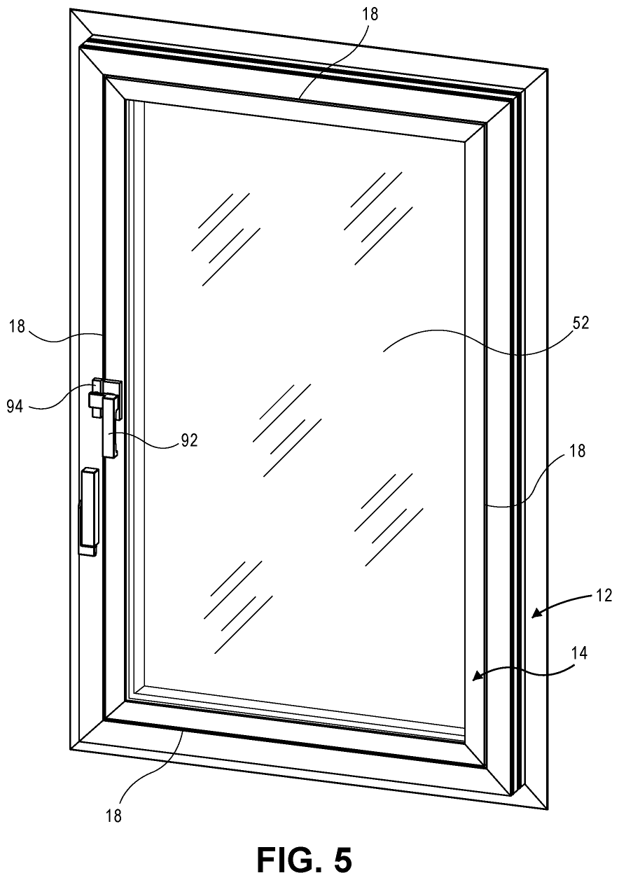

Referring to FIGS. 2-7, the present invention is directed to a window assembly 10 for installing in window opening of a building, such as a residential home, apartment building, or business office. The window assembly 10 includes a window frame 12 and a window sash 14 installed in the window frame 12. The window sash 14 is pivotally mounted in the window frame 12 such that the window sash 14 open and closes within the window frame 12. When the window sash 14 is in the closed position in the window frame 12, the window frame 12 and window sash 14 have a flush exterior interface 16 (see FIG. 3) and a flush interior interface 18 (see FIG. 5), between the window frame 12 and window sash 14.

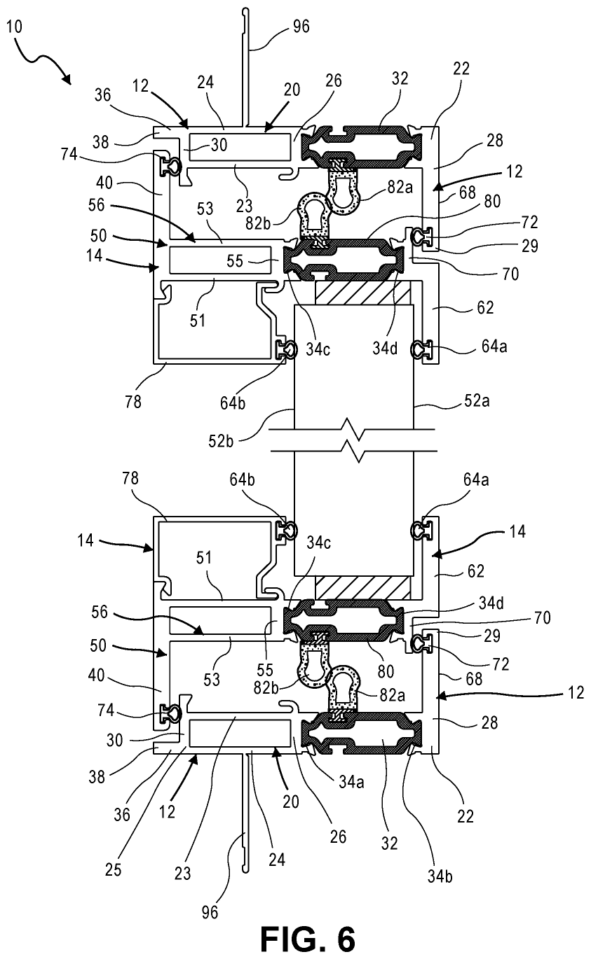

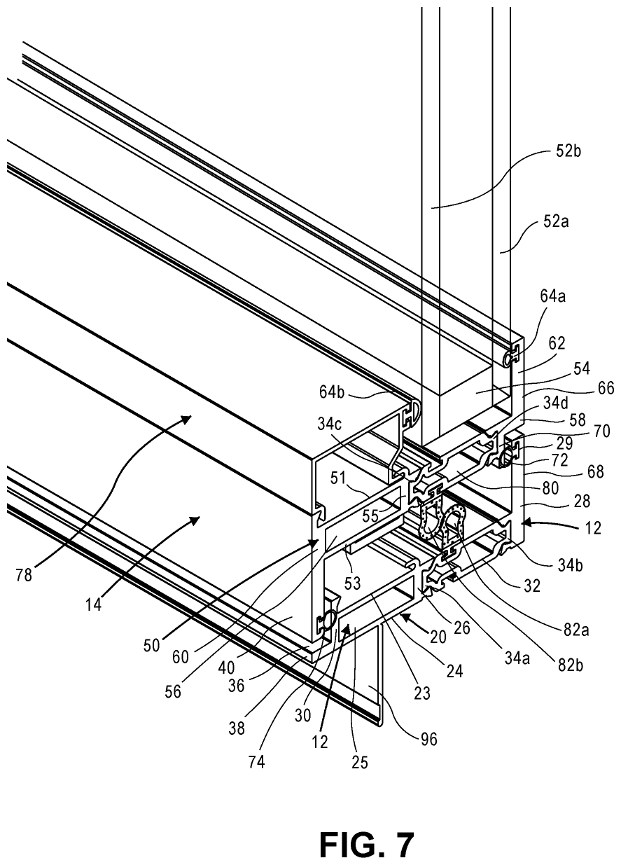

As best shown in the cross-sectional view of FIG. 6 and the cut-away view of FIG. 7, the window frame 12 includes a frame base 20 forming the outer portion of the frame 12. It is understood that the cross-section of the window assembly 10 extends around the entire rectangular perimeter of the window assembly 12, such that each of the elements of the window assembly 10 shown in the cross-section extends around the entire rectangular perimeter of the window assembly 10, as shown in FIGS. 2-5.

The frame base 20 extends laterally from an interior end 22 to an exterior end 25. The frame base 20 includes a rectangular structure having a plurality of walls. As used herein, the terms “interior” and “exterior” are relative to the “interior” and “exterior” of the window assembly in which the exterior is on the outside of the building and the interior is inside the building. As used herein, the terms “inward,” “inwardly,” and “inner”, and “outward,” “outwardly” and “outer”, are relative to the perimeter and middle of the window assembly in a elevational view of the window assembly, such that “inward,” “inwardly” and “inner” mean toward the middle of the window, and “outward”, “outwardly” and “outer” mean toward the perimeter of the window. The frame base 20 includes an inner wall 23 and an outer wall 24 which are connected by a divider wall 26, a frame interior wall 28 and a frame exterior wall 30. The frame interior wall 28 extends inwardly from the interior end of the outer wall 24, connects to the interior end of the inner wall 23, and extends inwardly past the interior end of the outer wall 24 to an inward end 29 of the frame interior wall 28.

The frame base 20 may optionally comprise a frame thermal break 32 between the interior portion of the frame base 20 and the exterior portion of the frame base 20. In the illustrated embodiment, the thermal break 32 is disposed between the interior wall 28 and the divider wall 26 such that it thermally separates the interior wall 28 and the exterior portion of the frame base 20. The frame thermal break 32 extends between, and connects, the divider wall 32 and the interior wall 28. The frame thermal break 32 connects to the divider wall 32 and to the interior wall 28 via respective tongue and groove connections 34a, 34b. The frame thermal break 32 is formed of a material having a low thermal conductivity compared to the interior wall 28, and the interior portion of the frame base 20. For example, the interior wall 28, divider wall 26, frame exterior wall 30, and interior portion of the inner wall 23 and outer wall 24 may be formed of a metal, such as aluminum (205 W/(m K)) or steel (50 W/(m K)), which have relatively high thermal conductivities. In contrast, the frame thermal break 32 may be formed of a polymer material, such as polyurethane (0.02 W/(m K)) or other suitable plastic material (about 0.02-0.50 W/(m K), which has a much lower thermal conductivity than metals like aluminum and steel.

The frame 12 also has an extension wall 36 extending exteriorly from the outer end of the frame exterior wall 30, such that the frame exterior wall 30 is recessed from the exterior end 38 of the extension wall 36. The extension wall 36 extends exteriorly such that the exterior end 38 of the extension wall 36 is flush with the outside surface of a sash exterior wall 40 of the window sash 14, as described below.

The frame 12 may also have a nail-fin 96 extending outwardly from the bottom of the frame base 20, such as extending outwardly from the outer wall 24. The nail-fin 96 is used to attach the frame 12 to the building walls surrounding the window opening, such as a wall stud or beam. Alternatively, the frame 12 may have other attachment devices, such as fastener holes or slots in the frame base 20.

The window sash 14 comprises a sash frame 50 and one or more glass panes 52 mounted in the sash frame 14. In the illustrated embodiment of FIGS. 2-7, the window sash 14 has two glass panes 52a and 52b. The glass panes 52a and 52b are held in the sash frame 50 and are separated by a spacer 54 such that there is a space between the glass panes 52a and 52b.

The sash frame 50 comprises a sash base 56 which extends from an interior end 58 to an exterior end 60. The sash base 56 includes an inner wall 51 and an outer wall 53 which are connected by a sash divider wall 55, an interior interface wall 70 and the sash exterior wall 40. A sash interior wall 62 extends inwardly from the interior end 28 of the sash base 56. The sash interior wall 62 forms one of the supports for holding the glass panes 52a and 52b. The inward end of the sash interior wall 62 has a first gasket 64a which bears against and holds the interior surface of the first glass pane 52a. An interior surface 66 of the sash interior wall 62 is flush with an interior surface 68 of the frame interior wall 28.

The sash frame 50 also has an interior interface wall 70 which extends outwardly from the sash base 56 at a position exterior of the sash interior wall 62, such that the interior interface wall 70 is recessed from the sash interior wall 62. The interior interface wall 70 seals against a frame seal 72 on the inside surface of the frame exterior wall 28 when the window sash 14 is in the closed position in the window frame 12. The interface of the interior surface wall 70 and the frame seal 72 allows the window sash 14 to open outward from the window frame 12. The sash exterior wall 40 extends outwardly from the exterior end 60 of the sash base 56. As previously described above, the exterior surface of the sash exterior wall 40 is flush with the exterior end 38 of the extension wall 36. The sash exterior wall 40 has a sash seal 74 which seals against the frame exterior wall 30 when the window sash 14 is closed in the window frame 12, and allows the window sash 14 to open outward from the window frame 12.

The sash frame 50 also has an exterior pane support 78 mounted on the exterior portion of the sash base 56. The exterior pane support 78 has a second gasket 64b which bears against and holds the exterior surface of the second glass pane 52b.

Similar to the frame base 20, the sash base 56 may optionally comprise a sash thermal break 80 between the interior portion of the sash base 56 and the exterior portion of the sash base 56. The sash thermal break 80 is disposed between the interior interface wall 70 and the sash divider wall 55 such that it thermally separates the interior interface wall 70 and the exterior portion of the sash base 56. The sash thermal break 80 extends between, and connects, the sash divider wall 55 and the interior interface wall 70. The sash thermal break 80 connects to the sash divider wall 55 and to the interior interface wall 70 via respective tongue and groove connections 34c, 34d. The sash thermal break 80 may be formed of the same types of material as the frame thermal break 32, and the other elements of the sash frame 50 may be formed of the same types of material as elements of the frame base 20.

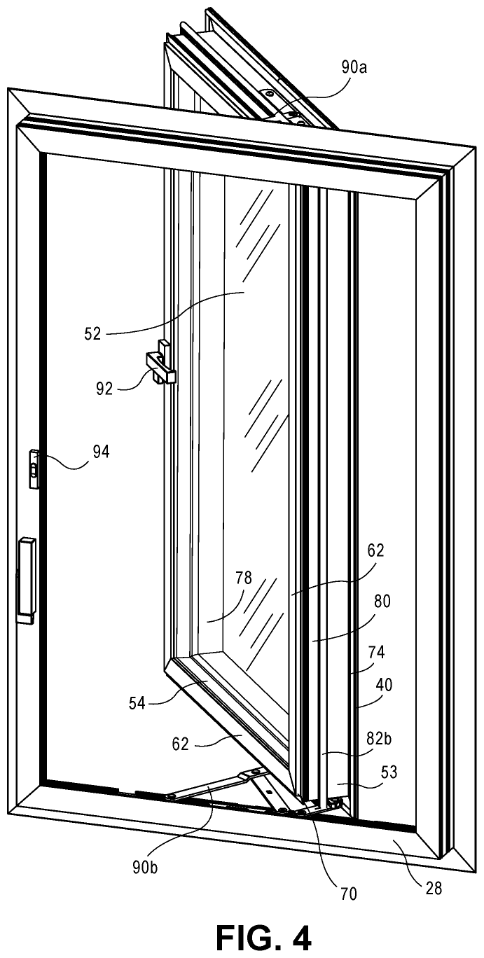

The window frame 12 and window sash 14 may also have respective convection air seals 82a and 82b to create an air barrier in the space between the window frame and the window sash 14. The air barrier created by the air seals 82a and 82b eliminate or at least reduce convective heat transfer between the exterior and interior of the window assembly 10. The air seal 82a is disposed on the inward side of the frame thermal break 32 and the air seal 82b is disposed on the outward side of the sash thermal break 80 such that the air seals 82a and 82b bear against each other when the window sash 14 is closed in the window frame and the air seal 82b is exterior to the air seal 82a thereby allowing the air seal 82b to move exteriorly when the window sash is rotated to the open position as shown in FIGS. 2 and 4.

As shown in FIGS. 2 and 4, the window sash 14 is pivotally connected to the window frame 12 by a pair of hinges 90, a top hinge 90a and a bottom hinge 90b. As depicted in FIGS. 2-5, the window sash 14 is pivotable between a closed position in the window frame 12 (see FIGS. 2 and 4) and an open position (see FIGS. 3 and 5). The window assembly 10 also includes a locking handle 92 and latch 94 on the interior side of the window sash 14 and window frame 12, respectively, for locking the window sash 14 in the closed position in the window frame 12.

Although particular embodiments have been shown and described, it is to be understood that the above description is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims. For example, not all of the components described in the embodiments are necessary, and the invention may include any suitable combinations of the described components, and the general shapes and relative sizes of the components of the invention may be modified. The invention, therefore, should not be limited, except to the following claims, and their equivalents.

What is claimed is:

1. A window assembly for a building, comprising:
a window frame for mounting in a window opening of a wall of a building, and a window sash pivotally mounted to the window frame, the window sash being pivotable from a closed position in the window frame to an open position;
the window frame including a frame base having an interior end and an exterior end and an outer wall forming the outer perimeter of the window frame, a frame interior wall extending inwardly from the interior end of the frame base, a frame exterior wall extending inwardly from the exterior end of the frame base and an extension wall extending exteriorly from the frame exterior wall and having an exterior end;
the window sash including a sash frame and a glass assembly having one or more glass panes mounted in the sash frame, the sash frame having an exterior end and an interior end, an interior wall extending inwardly from the interior end of the sash base, an interior surface of the sash interior wall being flush with an interior surface of the frame interior wall when the window sash is in the closed position in the window frame, an interior interface wall which extends outwardly from the sash base at a location exterior of the sash interior wall such that the interior interface wall is recessed from the sash interior wall, and a sash exterior wall extending outwardly from the sash base; and
wherein the exterior surface of the sash exterior wall is flush with the exterior end of the extension wall when the window sash is in the closed position.

2. The window assembly of claim 1, wherein the frame base comprises a frame thermal break separating an interior portion of the frame base from an exterior portion of the frame base.

3. The window assembly of claim 2, wherein the frame thermal break is made of a material selected from the group consisting of plastic and polyurethane.

4. The window assembly of claim 3, wherein the interior portion of the frame base and the exterior portion of the frame base are made of a metal material.

5. The window assembly of claim 1, wherein the sash base comprises a sash frame thermal break separating an interior portion of the sash base from an exterior portion of the sash base.

6. The window assembly of claim 5, wherein the interior portion of the sash base and the exterior portion of the sash base are made of a metal material.

7. The window assembly of claim 6, wherein the sash thermal break is comprised of a material selected from the group consisting of plastic and polyurethane.

8. The window assembly of claim 1, further comprising a first convection seal and a second convection seal, the first convection seal disposed on an inward surface of the frame base and the second convection seal disposed on an outward surface of the sash base, the first convection seal and second convection seal positioned such that they seal against each other when the window sash is in the closed position in the window frame.

9. The window assembly of claim 1, wherein the second convection seal is positioned exterior to the first convection seal.

10. The window assembly of claim 1, further comprising a first pane seal disposed on an exterior surface of the interior interface wall which bears against and holds an interior surface of the glass assembly.

11. The window assembly of claim 10, further comprising a second pane seal disposed on an interior surface of the exterior pane support which bears against and holds an exterior surface of the glass assembly.

12. The window assembly of claim 1, wherein the window frame is installed in a window opening of a building.

13. The window assembly of claim 12, wherein an exterior surface of the window frame and an exterior surface of the window sash are flush with an exterior surface of the wall.

14. The window assembly of claim 12, wherein an interior surface of the window frame and an interior surface of the window sash are flush with an interior surface of the wall.

15. A window assembly for a building, comprising:
a window frame for mounting in a window opening of a wall of a building, and a window sash pivotally mounted to the window frame, the window sash being pivotable from a closed position in the window frame to an open position;
the window frame having a frame exterior structure forming the most exterior part of the window frame, and a frame interior structure forming the most interior part of the window frame;
the window sash having a sash exterior structure forming the most exterior part of the window sash and a sash interior structure forming the most interior part of the window sash;
wherein, when the window sash is in the closed position in the window frame, the frame exterior structure is flush with the sash exterior structure and the frame interior structure is flush with the sash exterior structure.

16. The window assembly of claim 15, wherein:
the window frame includes a frame base having an interior end and an exterior end and an outer wall forming the outer perimeter of the window frame, and a frame exterior wall extending inwardly from the exterior end of the frame base, the frame interior structure comprising a frame interior wall extending inwardly from the interior end of the frame base, and the frame exterior structure comprising an extension wall extending exteriorly from the frame exterior wall and having an exterior end; and
the window sash includes a sash frame and a glass assembly having one or more glass panes mounted in the sash frame, the sash frame having an exterior end and an interior end, the sash interior structuring comprising a sash interior wall extending inwardly from the interior end of the sash base, and the sash exterior structure comprising a sash exterior wall extending outwardly from the exterior end of the sash base.

17. The window assembly of claim 16, wherein the frame base comprises a frame thermal break separating an interior portion of the frame base from an exterior portion of the frame base, and the sash base comprises a sash frame thermal break separating an interior portion of the sash base from an exterior portion of the sash base.

18. The window assembly of claim 17, wherein the frame thermal break and the sash frame thermal break are made of a material selected from the group consisting of plastic and polyurethane.

19. The window assembly of claim 19, wherein the interior portion of the frame base and the exterior portion of the frame base are made of a metal material, and the interior portion of the sash base and the exterior portion of the sash base are made of a metal material.

20. The window assembly of claim 19, further comprising a first convection seal and a second convection seal, the first convection seal disposed on an inward surface of the frame base and the second convection seal disposed on an outward surface of the sash base, the first convection seal and second convection seal positioned such that they seal against each other when the window sash is in the closed position in the window frame.
